(19) United States
(12) Patent Application Publication
(10) Pub. No.: US 2008/0018644 A1
(43) Pub. Date: Jan. 24, 2008

(54) Method of Automatically Extracting Configuration Approximations Via Nested Geometric Refinements

(75) Inventor: John F. Dannehoffer III, Manlius, NY (US)

Correspondence Address: BOND, SCHOENECK & KING, PLLC, ONE LINCOLN CENTER, SYRACUSE, NY, 13202-1355, US

(73) Assignee: Syracuse University, Syracuse, NY (US)

(21) Appl. No.: 11/779,950

(22) Filed: Jul. 19, 2007

Related U.S. Application Data
(60) Provisional application No. 60/807,769, filed on Jul. 19, 2006.

(51) Int. Cl. G06T 17/00

(52) U.S. Cl. 345/420

(57) ABSTRACT

A method of extracting configurations from assemblies of CAD parts with both large and small features. The technique uses a nested set of Cartesian cells as well as adjoint-based adaptation. Small features are initially ignored and are only resolved if needed; thereby saving computer time and memory. Configurations that are composed of assemblies of parts are handled automatically by the method and a user thus does not need to artificially close a configuration first in order to generate a computational grid. Adjoint-based adaptation is used to automatically select those features that need to be resolved. This step, when combined with field adaptation, yields a highly-effective method of computing flows over a variety of configurations.

### CROSS-REFERENCE TO RELATED APPLICATIONS

This application claims priority to U.S. Provisional Patent Application Ser. No. 60/807,769, filed Jul. 19, 2006, the entirety of which is hereby incorporated by reference.

### BACKGROUND OF THE INVENTION

1. Field of the Invention

The present invention relates to fluid dynamics and, more particularly, to a method for processing configurations in a computer-aided design (CAD) system.

2. Description of the Related Art

The pacing item in the application of computational fluid dynamics (CFD) to new configurations is the pre-processing phase, of which preparation of the geometry is the most time-consuming step. This is especially true for configurations that are defined in a computer-aided design (CAD) system. The primary reason for this difficulty is the existence of both large and small features, some of which are not needed to achieve the results desired by the customer. Users can sometimes remove small unwanted features by suppressing them in the CAD system; this however is not an option when the features emerge during the assembly of parts into a whole model.

### BRIEF SUMMARY OF THE INVENTION

It is therefore a principal object and advantage of the present invention to provide a method for automatically extracting a computational model from an assembly of parts with features of varying resolutions.

It is another object and advantage of the present invention to provide a method for automatically extracting a computational model from an assembly of parts that is efficient.

It is a further object and advantage of the present invention to provide a method for automatically extracting a computational model from an assembly of parts that only resolves the pertinent features.

In accordance with the foregoing objects and advantages, the present invention provides a method for automatically extracting a computational model from an assembly of parts with features of varying resolutions. The method of the present invention is referred to as nested geometric refinement. When the present invention is first applied, the invention generates a configuration approximation that has a globally-applied user-defined resolution that is independent of the local feature size. A simple adaptation process is then applied by the present invention to resolve geometric features only where needed. The present invention is very efficient, since small features are ignored in the initial representation. Grids can be generated on assemblies, regardless of how well the parts fit together. Through the use of an adaptation in accordance with the present invention, the configuration can be refined such that only the pertinent features are resolved.

### BRIEF DESCRIPTION OF THE DRAWINGS

The present invention will be more fully understood and appreciated by reading the following Detailed Description in conjunction with the accompanying drawings, in which:

FIG. 1A through 1D is a series of diagram illustrating the application of the method of the present invention.

FIG. 2 is a diagram illustrating the results of the application of the method of the present invention.

FIG. 3A through 3F is a series of diagrams illustrating the application of the method of the present invention to a first example.

FIG. 4A through 4D is a series of diagrams illustrating the application of the method of the present invention to a second example.

FIG. 5A through 5D is a series of diagrams illustrating the application of the method of the present invention to a third example.

### DETAILED DESCRIPTION OF THE INVENTION

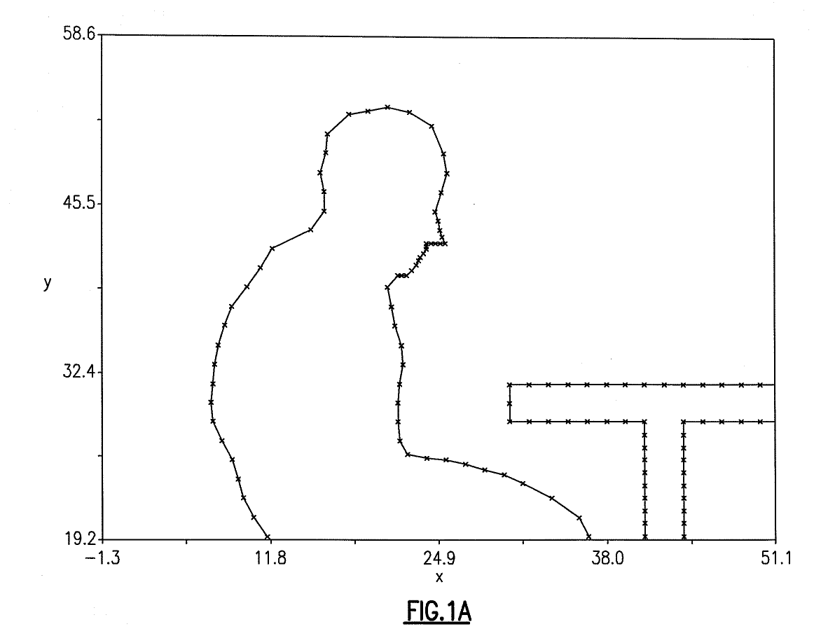

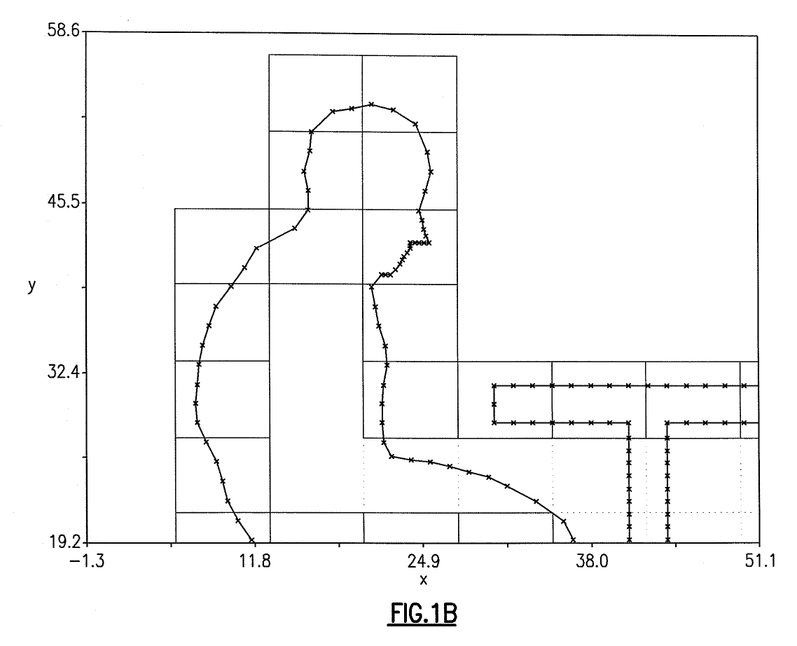

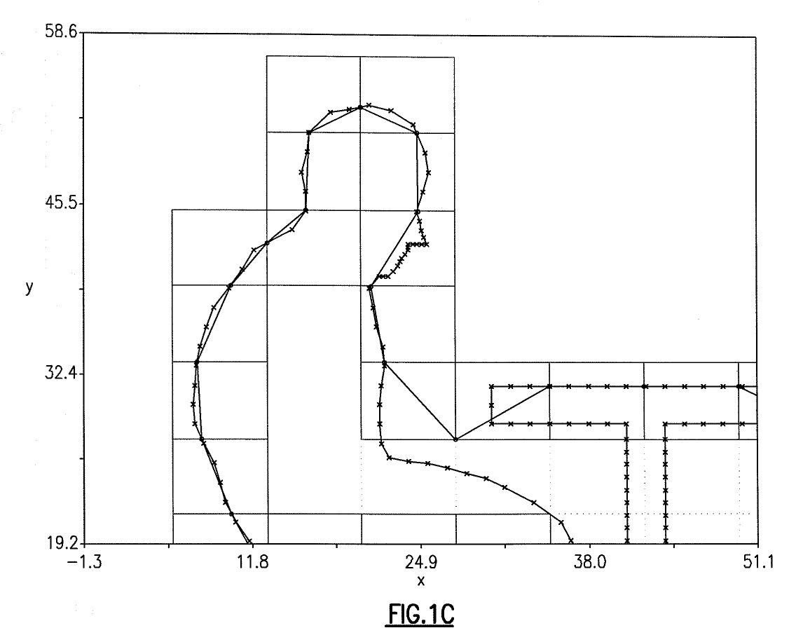

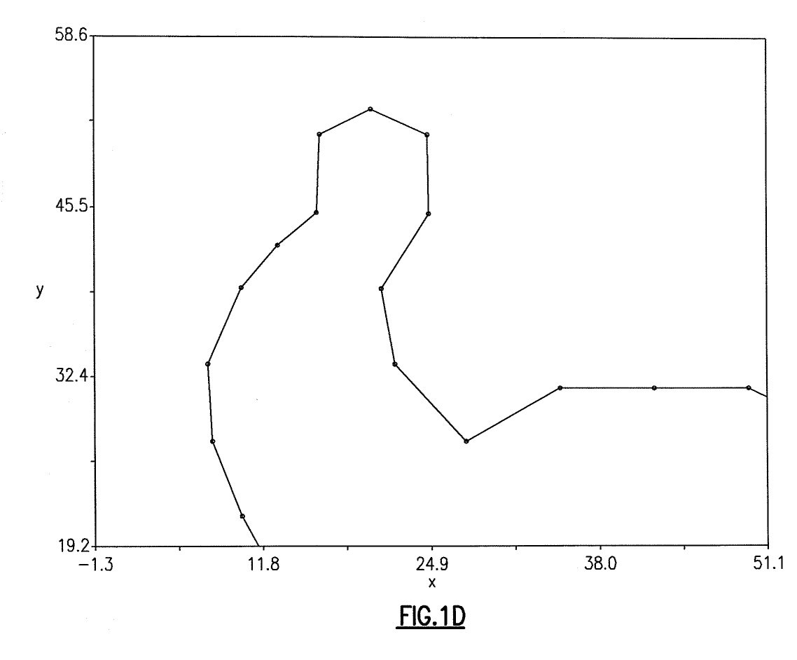

Referring now to the drawings, wherein like reference numerals refer to like parts throughout, there is seen in FIG. 1A through 1D a series of computer aided design configurations that illustrate the application of the present invention. The first step of a method according to the present invention is referred to as configuration to approximation. This step involves converting the original configuration, which may consist of a single part or of an assembly, into an approximation by generating a Cartesian grid superimposed on the configuration. FIG. 1A depicts the original configuration and FIG. 1B shows the superimposed Cartesian grid according to the present invention. The places where the configuration “crosses” the Cartesian grid forms a set of points, seen in FIG. 1C each of which are then interconnected to yield the approximation shown in FIG. 1D.

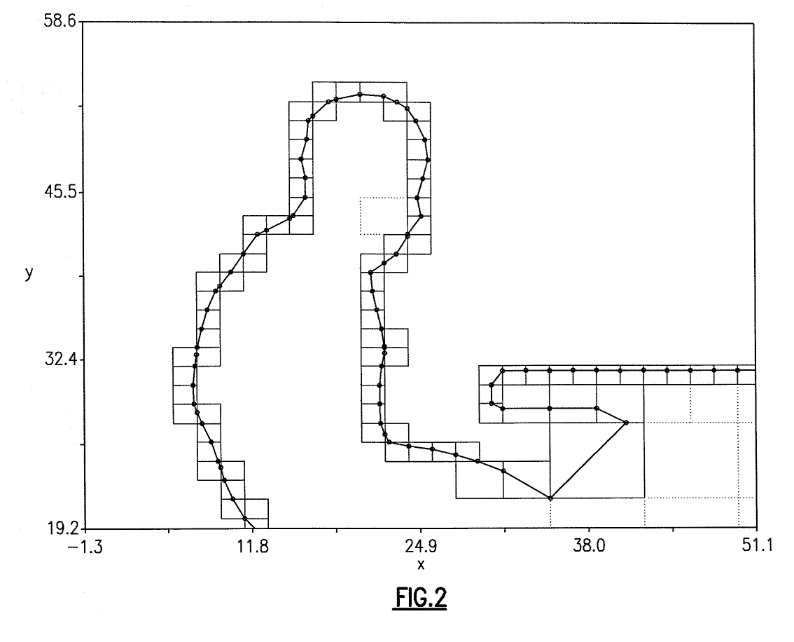

The next step of a method according to the present invention is referred to as nested refinement, and involves refining the configuration by splitting the Cartesian cells that cross the configuration into quarters. The result of this step of the method is seen in FIG. 2. Because of the complexity of the configuration near the example of the head of the person in FIG. 2, all the cells are refined evenly. But in the vicinity of the table in the example seen in FIG. 2, Cartesian cells of various sizes can be seen. This variance allows refinement of the configuration only where needed.

In the final step of a method according to the present invention, referred to as “adaptation,” techniques based upon an adjoint formulation of the flow solver are used to refine the configuration. The adaptation is implemented by first computing the “change” in the configuration that would result from local refinement of the configuration. An adjoint version of the flow solver is then used to compute the “gradient” of the objective function with respect to the boundary perturbations. The product of these two is then used as the adaptation trigger in the results that follow.

### EXAMPLES

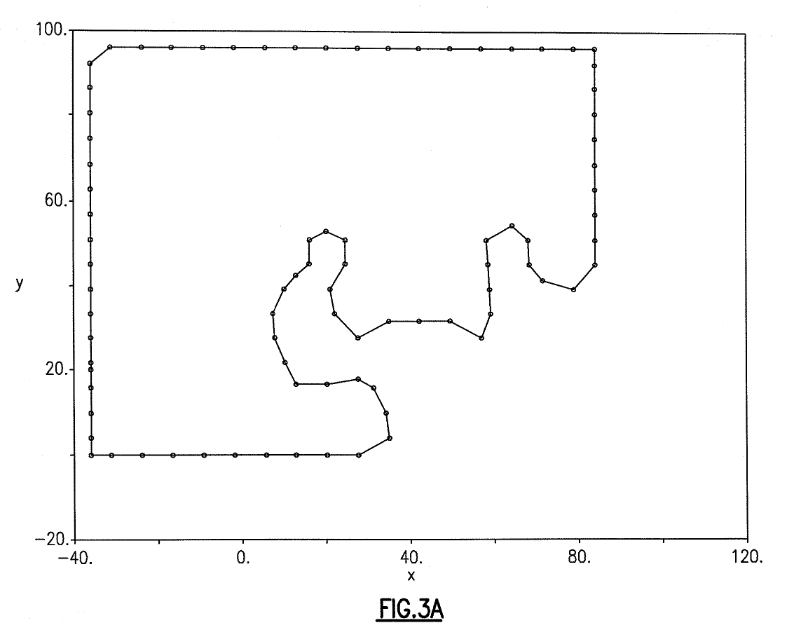

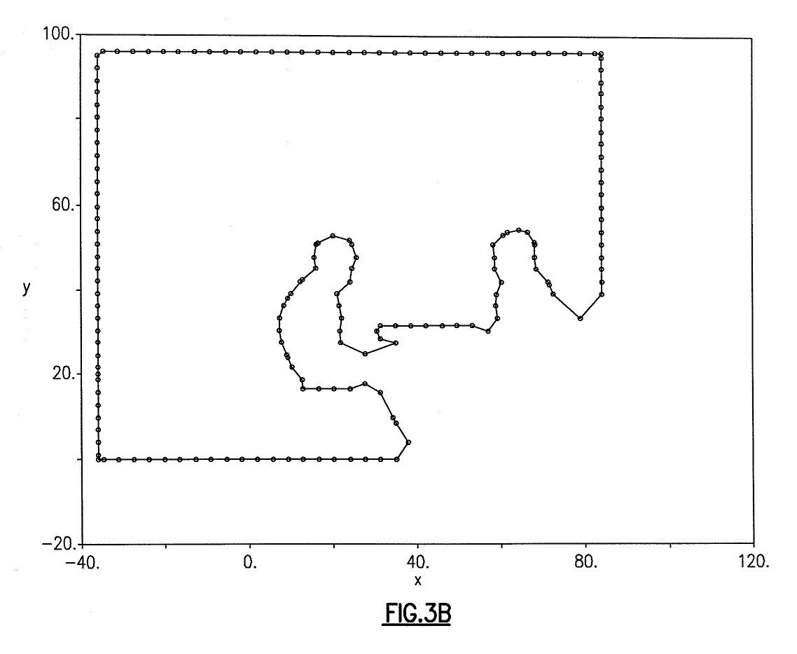

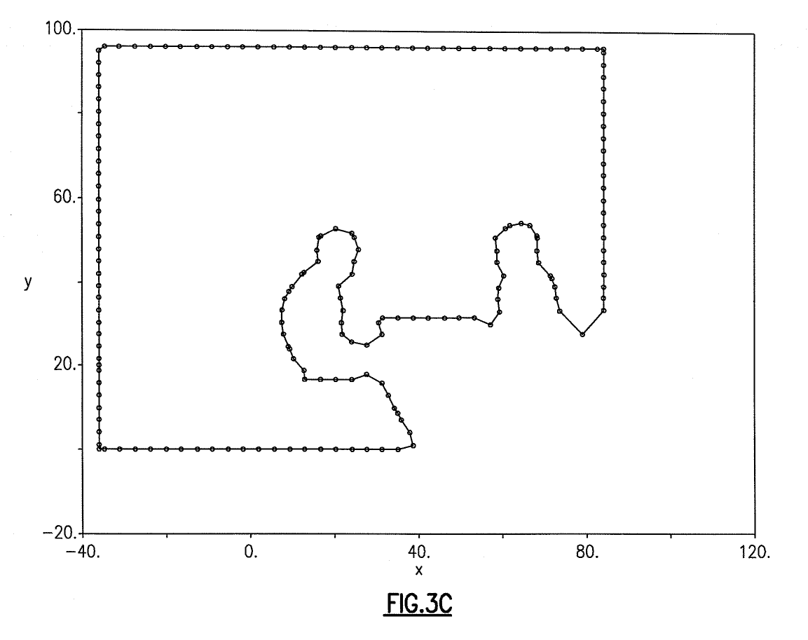

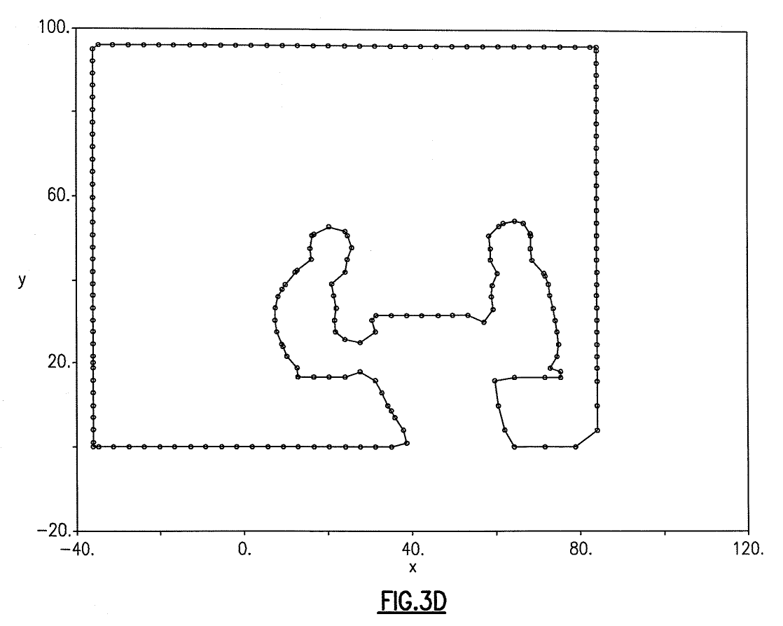

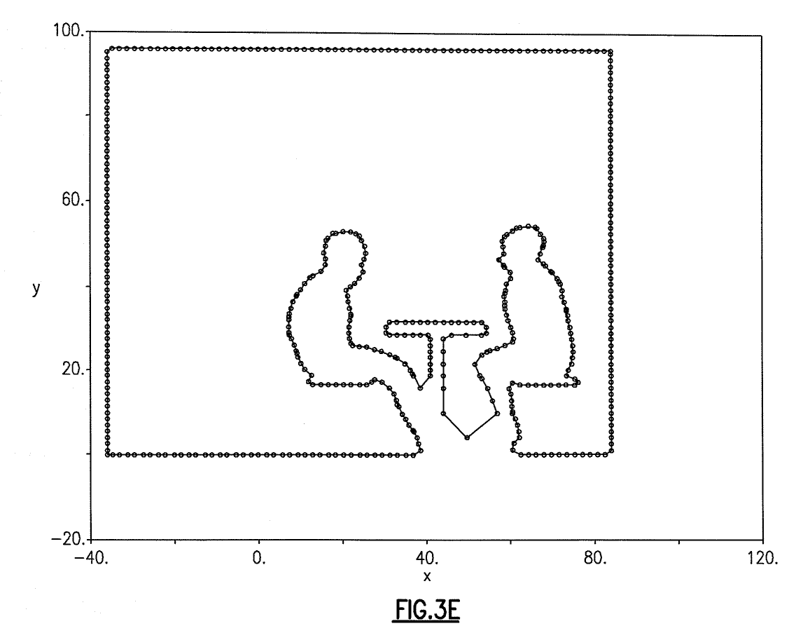

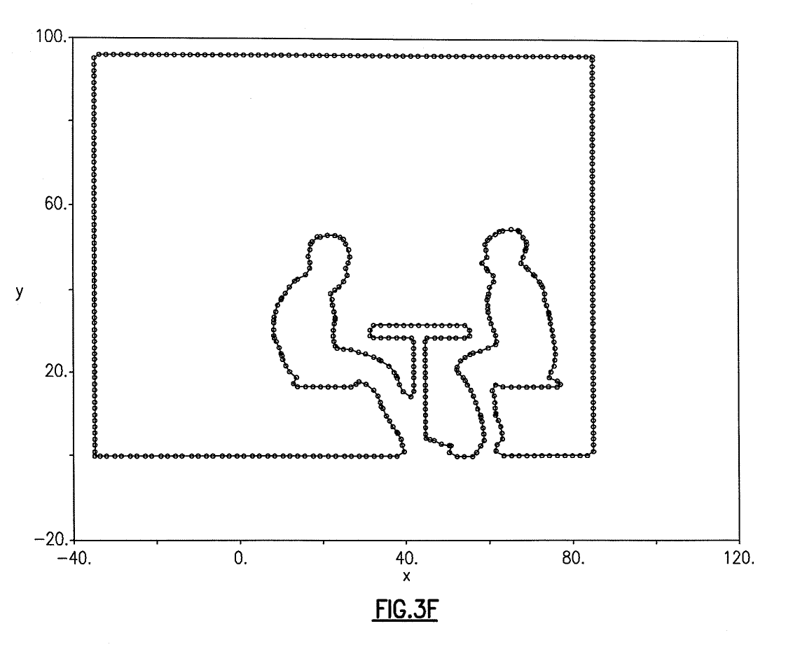

Referring to FIG. 3, which shows the original approximation of the configuration in FIG. 1A and the effect of successive global refinements of the configuration in FIG. 1B through 1F, an example is shown for the flow in a room occupied by two people sitting at a table. As seen in FIG. 3, the global refinements do not appreciably change the definition of the faces of the people, but instead resolves the regions between the people or between the people and the wall.

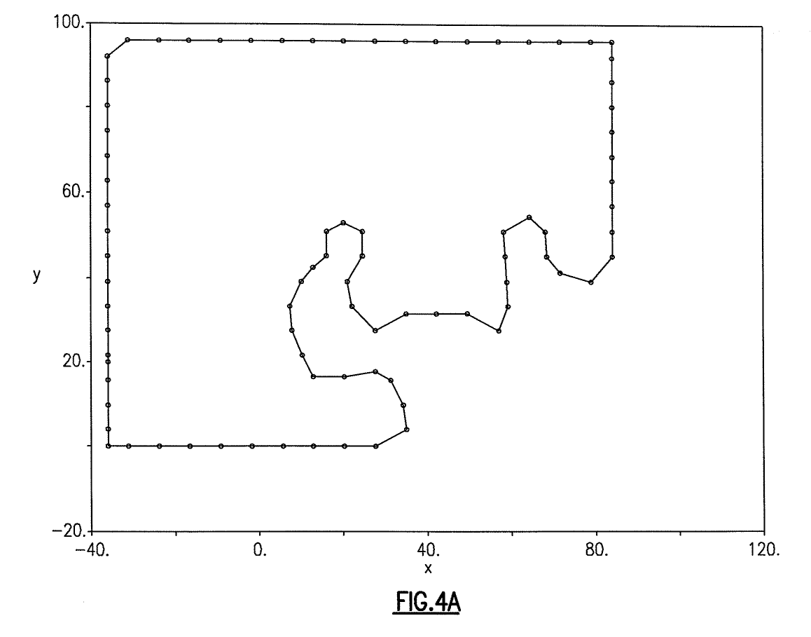

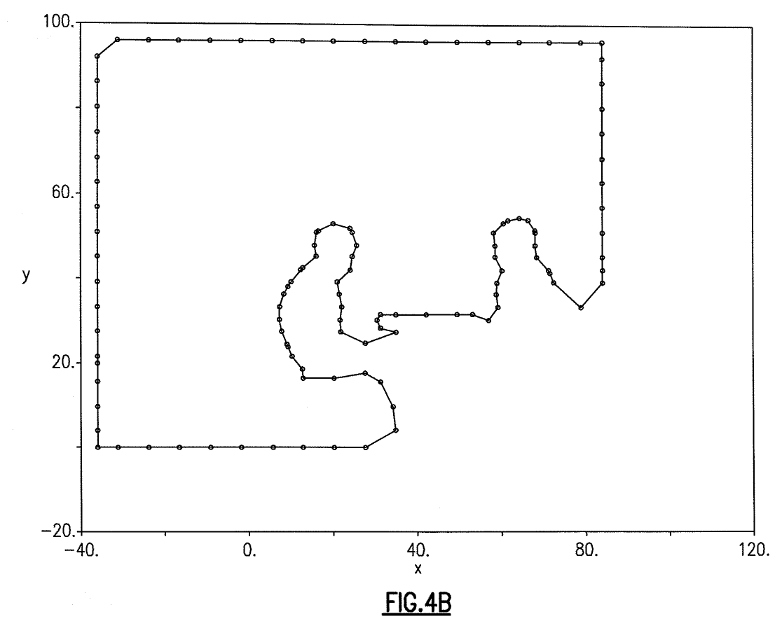

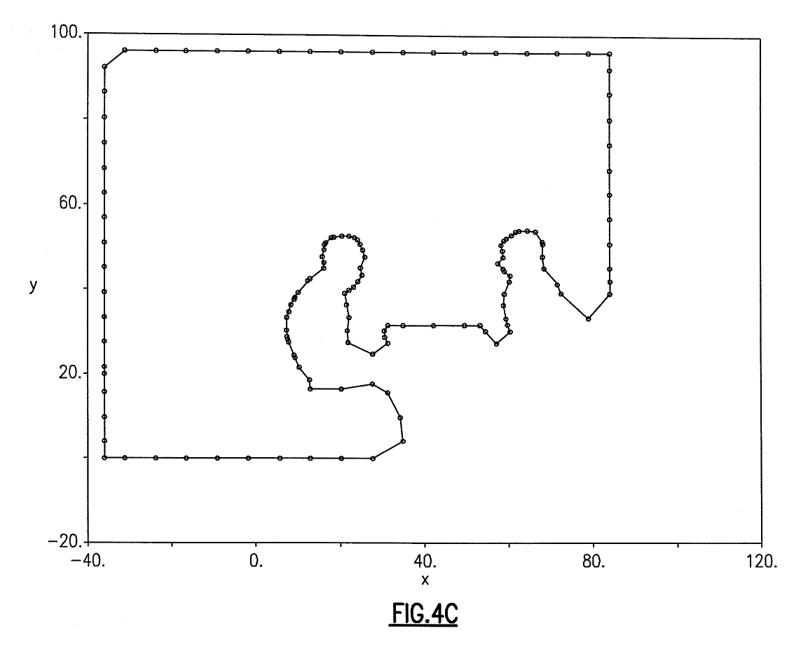

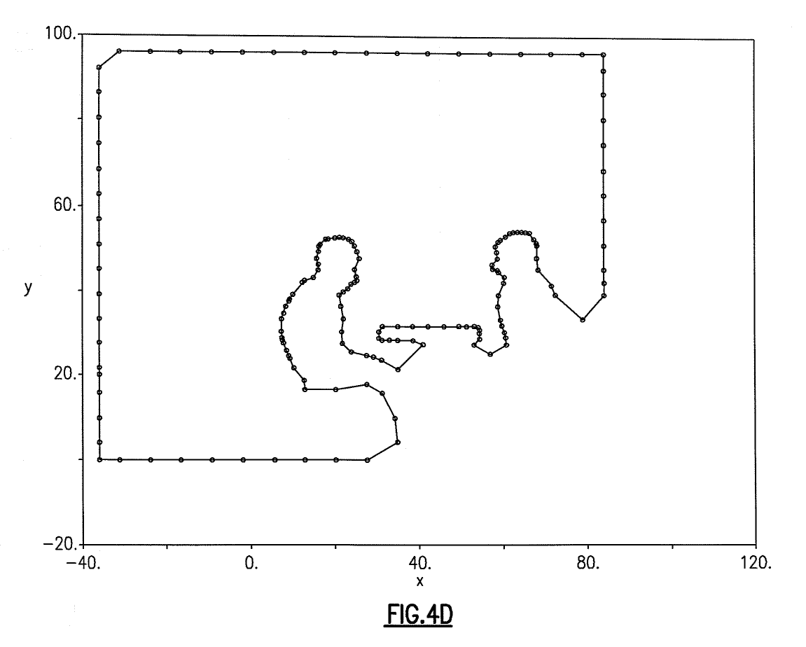

Refinements for the same configuration can be generated adaptively. Referring to FIG. 4A through 4D, the objective function is an accurate prediction of the flow in the vicinity of the breathing zone of the left-hand person. Successive adaptations yield more accuracy of the shape of the head of the person, but does not refine the region between the right-hand person and the wall.

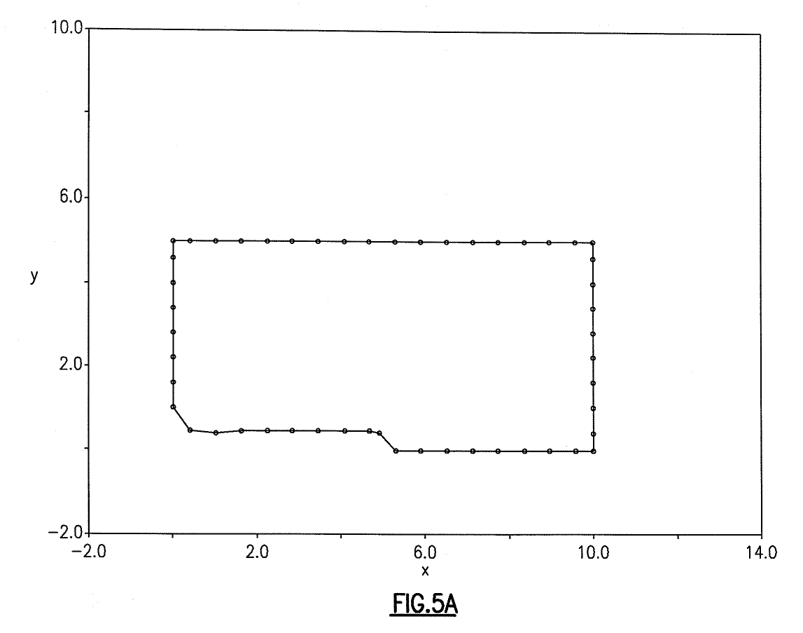

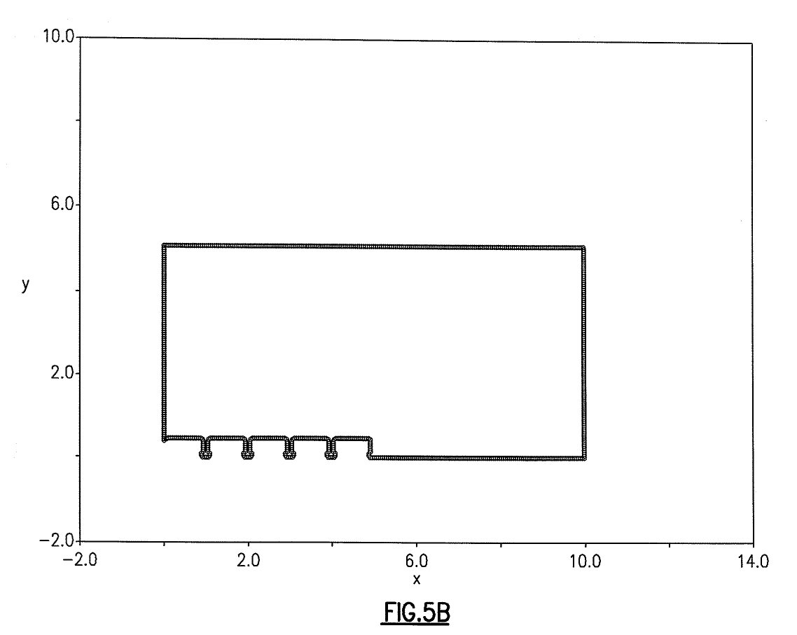

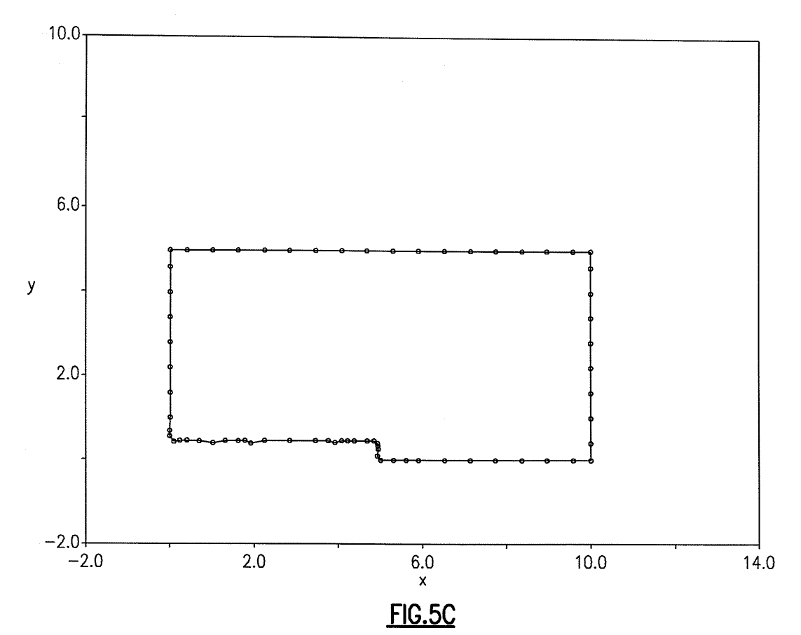

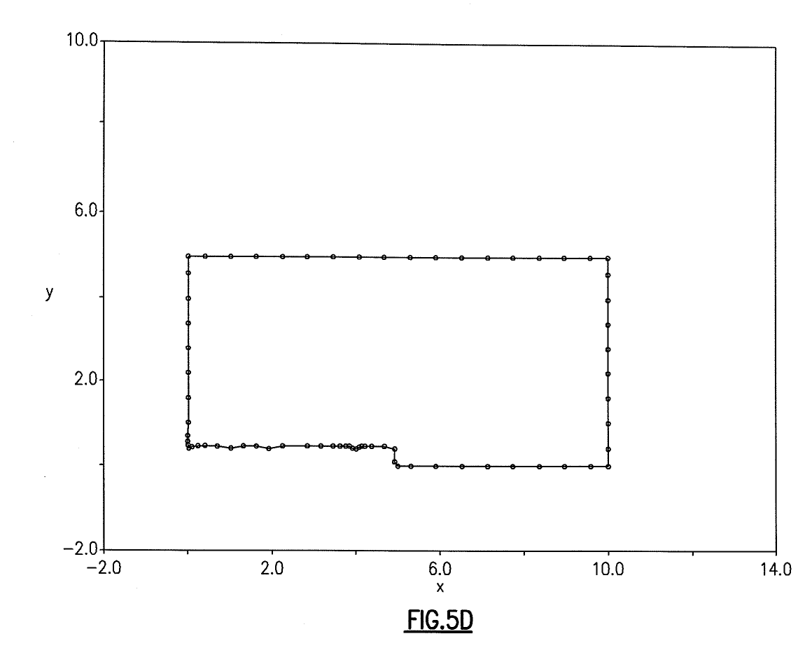

Referring to FIG. 5A through 5D, an example comprising five “blocks” near the lower wall of a channel is employed to show the original approximation of the assembly, as seen in FIG. 5A, and the effect of global refinement on the assemble, as seen in FIG. 5B. FIG. 5C through 5F show the different configurations that result from three levels of adaptation, where the adaptation is aimed at an accurate solution to the right of the 5th block in FIG. 5C and between the 4th and 5th blocks in FIG. 5D. As seen in FIG. 5A through 5D, different objective functions result in very different approximations to the original configuration.

What is claimed is:

1. A method for creating a computational model from a configuration, comprising the steps of:
converting the configuration into an approximation using a superimposed coordinate system;
refining the approximation by subdividing the grid in regions of complexity; and
adapting the approximation using an adjoint formulation.

2. The method of claim 1, wherein the step of converting a configuration into an approximation using a superimposed grid comprises superimposing a grid on the configuration.

3. The method of claim 2, wherein the step of refining the approximation by subdividing the grid in regions of complexity comprises dividing the grid into quarters wherever the cells of the grid intersect the configuration.

4. The method of claim 3, wherein the step of adapting the approximation using an adjoint formulation comprises the steps of computing the change in the configuration that would result from local refinement of the configuration, computing the gradient of the objective function with the respect to boundary perturbations, and calculating the product of the change in the configuration and the gradient of the object function.

5. The method of claim 4, wherein the grid is a Cartesian grid.

6. The method of claim 1, further comprising the step of further adapting the approximation using additional adjoint formulations.
